(19) United States
(12) Patent Application Publication
(10) Pub. No.: US 2025/0322998 A1
(43) Pub. Date: Oct. 16, 2025

(54) Keycap with an Interchangeable Keycap Top

(71) Applicants: Kyle LeBlanc, Hooksett, NH (US); Haley Laliberte, Northwood, NH (US); Christian Paradis, Manchester, NH (US)

(72) Inventors: Kyle LeBlanc, Hooksett, NH (US); Haley Laliberte, Northwood, NH (US); Christian Paradis, Manchester, NH (US)

(21) Appl. No.: 18/632,091

(22) Filed: Apr. 10, 2024

(51) Int. Cl. H01H 13/83; G06F 3/02; H01H 13/04; H01H 13/14

(52) U.S. Cl. CPC H01H 13/83; H01H 13/04; H01H 13/14; G06F 3/0202; H01H 2219/004; H01H 2231/002

(57) ABSTRACT

The present disclosure teaches a keycap with an interchangeable keycap top. The keycap comprises a keycap base and a keycap top. Wherein, a first magnetic piece connects to the keycap base, and a second magnetic piece connects to the keycap top. Both magnetic pieces can be a magnet or of a magnetic material, and at least one of the magnetic pieces is a magnet. The keycap top can thus be secured onto the keycap base by attaching the first magnetic piece to the second magnetic piece. The keycap top may be textured, have a distinctive shape, or have a distinctive coloring, or have other features, to provide physical and visual cues for a user. The present disclosure also teaches a customizable keyboard and a method of customizing such keyboard using said interchangeable keycap tops.

### TECHNICAL FIELD

The present disclosure relates to computer appliances, or more specifically, computer keyboards.

### BACKGROUND

A standard computer keyboard can a hard-to-use “game controller” because most of the keys are of the same sizes and shapes. A gamer could easily lose their hand positioning on the keyboard when they are playing a fast-paced video game, and thus, inexperienced gamers may find it hard to build muscle memory on a standard computer keyboard. A non-gamer computer user may also experience frustration when using one of these applications with multiple shortcuts and key bindings. Therefore, it could be helpful to provide physical and visual cues to remind a user where the input they desire resides on the computer keyboard.

A few solutions have been devised to solve this problem, including rubberized key covers, the FPS/MOBA performance keycaps, coloring the keycaps, using artisan keycaps, and having a macropad. However, none of these solutions are perfect. Rubberized key covers can provide a texture for keys, but the texture of a rubberized key cover may not be distinguishable enough from a regular key to provide easily identifiable physical cues to the user. The FPS/MOBA performance keycaps are specifically designed for gaming, but their layout is inflexible and may lock a user into predetermined hand positionings. Colors cannot be distinguished by touch, and a user would have to look down when playing a fast-paced game. Artisan keycaps are made for visual appeals instead of practicality. Macropads are tailor-made devices that attempt to solve issues by reducing the standard keyboard layout to a more manageable size. However, macropads may have extremely limited utility for non-gaming applications.

Therefore, the present disclosure aims to solve the problem by using interchangeable keycap tops for users to customize their keyboard. The interchangeable keycap tops can have different textures, shapes, lettering, and colors to provide physical and visual cues for a user.

### SUMMARY

The present disclosure teaches a keycap, comprising: a keycap base, wherein a first magnetic piece is connected to the keycap base; one or more keycap tops, wherein a second magnetic piece is connected to each of the one or more keycap tops; wherein each of the one or more keycap tops defines a tab or cutout on a back side; wherein the first magnetic piece is a magnet or a non-magnet magnetic material piece; wherein the second magnetic piece is a magnet or a non-magnet magnetic material piece; wherein at least one of the first and second magnetic pieces is a magnet.

In some embodiments, at least one of the one or more keycap tops may include a lettering component.

In some embodiments, the lettering component may protrude upward.

In some embodiments, the keycap base may include a light, and the lettering component may be transparent or semitransparent.

In some embodiments, at least one of the one or more keycap tops may have a shaped or textured surface.

In some embodiments, at least one of the one or more keycap tops may include a visual indicator.

In some embodiments, a top surface of the keycap base and a bottom surface of each of the one or more keycap tops may have matched shapes.

The present disclosure also teaches a customizable keyboard, comprising: a keyboard base; a plurality of keycaps with interchangeable keycap tops, as described above.

The present disclosure also teaches a method for customizing a keyboard, wherein the keyboard includes: a keyboard base; a plurality of keycap bases, wherein a first magnetic piece is connected to the keycap base; a first group of and a second group of keycap tops, wherein a second magnetic piece is connected to each of the first group and the second group of keycap tops; wherein each of the first group and the second group of keycap tops defines a tab or cutout on a back side; wherein the first magnetic piece is a magnet or a non-magnet magnetic material piece; wherein the second magnetic piece is a magnet or a non-magnet magnetic material piece; wherein at least one of the first and second magnetic pieces is a magnet; wherein each of the second group of keycap tops includes one or more physical or visual indicators; wherein the method comprises: selecting and securing keycap tops from the first group of keycap tops to corresponding keycap bases from the plurality of keycap bases; choosing an application; identifying one or more target keys that are commonly used for the application; identifying a target group of keycap bases corresponding to the one or more target keys; detaching keycap tops from the first group of keycap tops from the target group of keycap bases, using the tab or cutout; selecting and securing keycap tops from the second group of keycap tops to the target group of keycap bases.

In some embodiments, each of the first group of keycap tops includes a lettering component.

In some embodiments, the lettering component may protrude upward.

In some embodiments, each of the plurality of keycap bases may include a light, and the lettering component may be transparent or semitransparent.

In some embodiments, each of the second group of keycap tops may have a shaped or textured surface.

In some embodiments, each of the first group of keycap tops may have a smooth surface.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1A is an isometric diagram illustrating the structure of a keycap with an interchangeable keycap top, when dissembled, according to some embodiments of the present disclosure;

FIG. 1B is an isometric front-view diagram illustrating the structure of a keycap with an interchangeable keycap top, when assembled, according to some embodiments of the present disclosure;

FIG. 1C is an isometric back-view diagram illustrating the structure of a keycap with an interchangeable keycap top, when assembled, according to some embodiments of the present disclosure;

FIG. 2 is another isometric diagram illustrating the structure of a keycap with an interchangeable keycap top, when dissembled, with the interchangeable keycap top turned upside down, according to some embodiments of the present disclosure;

FIGS. 3A-D are illustrations of different textures and shapes the interchangeable keycap top may have, according to some embodiments of the present disclosure;

FIG. 4 is an illustration of a keyboard with interchangeable keycap tops, wherein the lettering on the keycap tops protrudes upward to provide physical indications for a user, according to one embodiment of the present disclosure;

FIG. 5 is another illustration of a keyboard with interchangeable keycap tops, wherein some of the keycap tops are textured or have distinctive shapes to provide physical indications for a user, according to one embodiment of the present disclosure.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

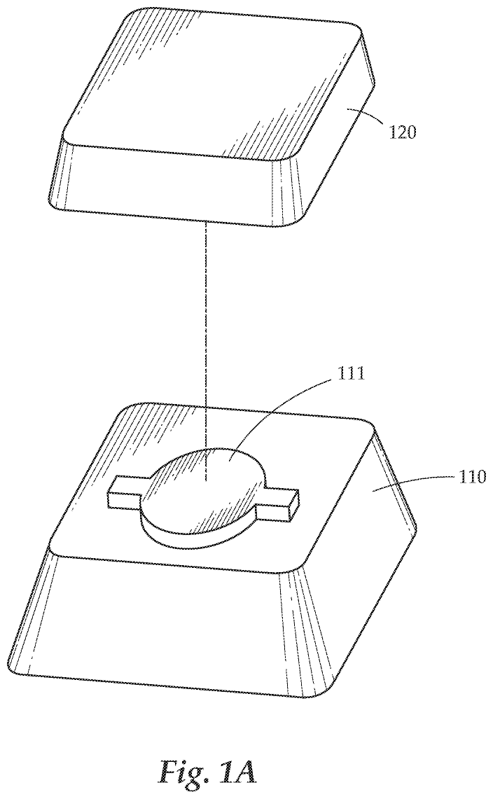

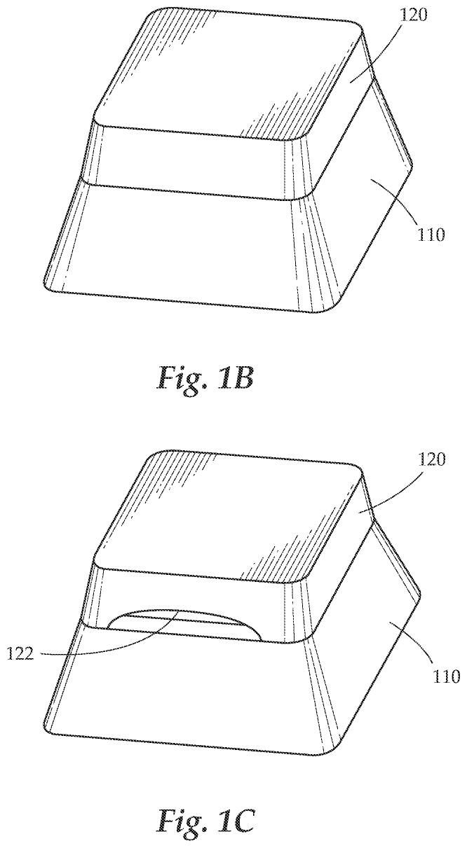

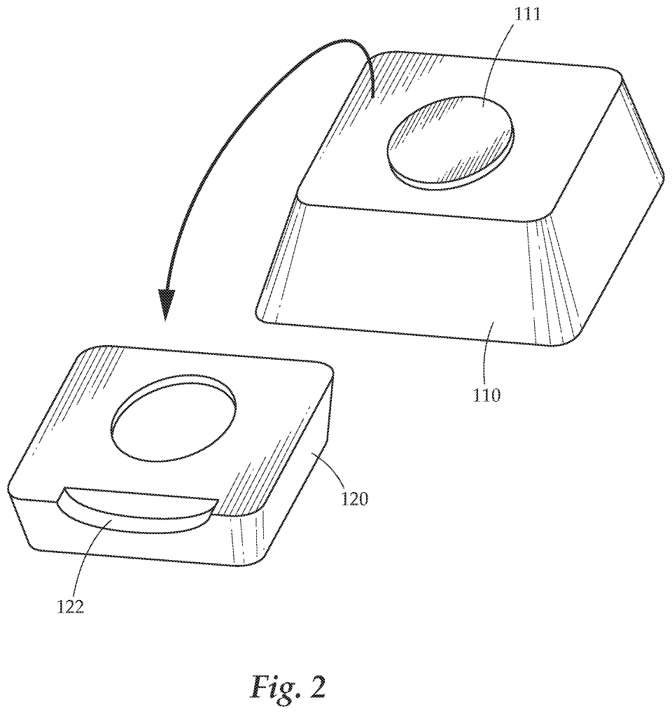

FIGS. 1A-C and FIG. 2 illustrate the structure of a keycap with an interchangeable keycap top, according to some embodiments of the present disclosure. FIG. 1A is an isometric diagram illustrating the structure of a keycap with an interchangeable keycap top, when dissembled. FIG. 1B is an isometric front-view diagram illustrating the structure of a keycap with an interchangeable keycap top, when assembled. FIG. 1C is an isometric back-view diagram illustrating the structure of a keycap with an interchangeable keycap top, when assembled. FIG. 2 is another isometric diagram illustrating the structure of a keycap with an interchangeable keycap top, when dissembled into the interchangeable keycap top and a keycap base, with the interchangeable keycap top turned upside down. Together, the interchangable keycap top and the keycap base makes a single key on a keyboard.

The keycap may comprise two parts, a keycap base 110 and a keycap top 120. The keycap base may connect to a first magnetic piece 111, and the keycap top 120 may connect to a second magnetic piece. Herein and after, “connect to” means “be attached to” or “be embedded in”. Such connection may be direct or indirect. A user may secure the keycap top 120 to the keycap base 110 by aligning the keycap top 120 and the keycap base 110 and attaching the second magnetic piece to the first magnetic piece 101.

Both the first magnetic piece 111 and the second magnetic piece may be magnets or made of a magnetic material. At least one of the first and second magnetic pieces 111 and 121 must be magnet. If both the first and second magnetic pieces 111 and 121 are magnets, they must be arranged in a way such that pole of the first magnetic piece 111 on the top side is attracted to the pole of the second magnetic piece on the bottom side.

The first magnetic piece 111 may be attached to the top surface of the keycap base 110 or embedded in the keycap base. Likewise, the second magnetic piece may be attached to the bottom surface of the keycap top 120 or embedded in the keycap top. In some embodiments, the entire keycap top 120 may be made of a magnetic material. For example, in some of the embodiments as illustrated by FIG. 1A and FIG. 2, the first magnetic piece 111 is a circular magnet piece attached to the center of the top surface of the keycap base 110.

Either the keycap base 110 or the keycap top 120, or both, may have recesses to match the shape of the first and/or second magnetic pieces 111 and 121. In some embodiments, the upper surface of the keycap base 110 may include a recess matching the shape of the first magnetic piece 111, so that the upper surface of the first magnetic piece roughly levels with the upper surface of the keycap base when the first magnetic piece is placed in the recess. In some other embodiments, the upper surface of the keycap base 110 may be flat, the first mangetic piece 111 may be attached on the upper surface of the keycap base, and the keycap top 120 may have a recess matching the shape of the first magnetic piece.

In some other embodiments, the keycap base 110 and the keycap top 120 may be connected by means other than magnetic connections. For example, the keycap base 110 and the keycap top 120 may be connected with an interlocking mechanism, a snap-fit connection, or a Velcro, etc. These non-magnetic connecting mechanisms may be used in conjunction with the magnetic connections.

Moreover, in some embodiments, the top surface of the keycap base 110 and the bottom surface of the keycap top 120 may have matching shapes, so that the keycap base and the keycap top can be properly aligned. The shape of the surfaces may be of a square with rounded corners, of a rectangle with rounded corners, of a quadrilateral with rounded corners, or of some other shapes. In some embodiments, the shape of the surfaces may be asymmetrical, so that the keycap top 120 must be of the correct orientation when the two surfaces are properly aligned.

In some embodiments, these matching shapes may be a mating protrusion and recession. In some embodiments, the matching shapes may be configured and shaped such that the keycap top 120 can only connect to the keycap base 110 in one orientation. The protrusion may either be one of the magnetic pieces, a part of one of the magnetic pieces, or a non-magnetic part of the keycap top or the keycap base. The mating protrusion and recession themselves may themselves form a connection mechanism. For example, they may form an interlocking mechanism or a snap-fit connection.

In some embodiments, the relative position of the first magnetic piece 111 with regard to the top surface of the keycap base 110 may correspond to the relative position of the second magnetic piece with regard to the bottom surface of the keycap top 120. For example, they may both be centered with regard to a horizontal cross-section of the keycap. So that, the first magnetic piece 111 can be properly attached to the second magnetic piece when the keycap base 110 and the keycap top 120 are properly aligned. In some embodiments, the magnetic pieces may not be placed in the center, so that the keycap top 120 must be of the correct orientation when the two magnetic pieces are properly aligned.

In some embodiments, the keycap top 120 may further include a tab or cutout 122. When a user needs to detach the keycap top 120 from the keycap 110, the user may separate the second magnetic piece from the first magnetic piece 111 by applying a force, such as an upward force and/or an angled force to the tab or cutout 122 using their fingertip. In some embodiments, the tab or cutout 122 may be located on the backside of the keycap top 120 for the user's convenience. In some embodiments, the tab or cutout 122 may be adjacent to or close to the bottom edge of the backside of the keycap top 120. Alternatively, in some embodiments, a cutout may be placed on the keycap base 110 to serve the same purpose, and it may be placed adjacent to the top edge of the backside of the keycap base. A user may detach the keycap top 120 from the keycap base 110 by applying an upward force and/or an angled force onto the back edge of the bottom surface of the keycap top, via the cutout, using their fingertip.

The function of a keycap is to provide input to a device when a user taps on the keycap. Therefore, there are usually one or more letters, numbers, or symbols on the top surface of the keycap reminding a user of the input corresponding to the keycap.

In some embodiments, the keycap top 120 may include a lettering component 201 on its top surface. The lettering component 201 may be one or more letters, numbers, or symbols. The letters may be of the Latin alphabet or may be of a non-Latin alphabet for the ease of multiligual users. For example, a user might speak English, Japanese, and Greek. The user may choose a keyboard with three sets of keycap tops-one of the Latin alphabet, one of Hiragana, and one of the Greek alphabet. When the user types in a different language, the user may choose a specific set of keycap tops. In some embodiments, the lettering component 201 may also be of the Braille alphabet for visually impaired users.

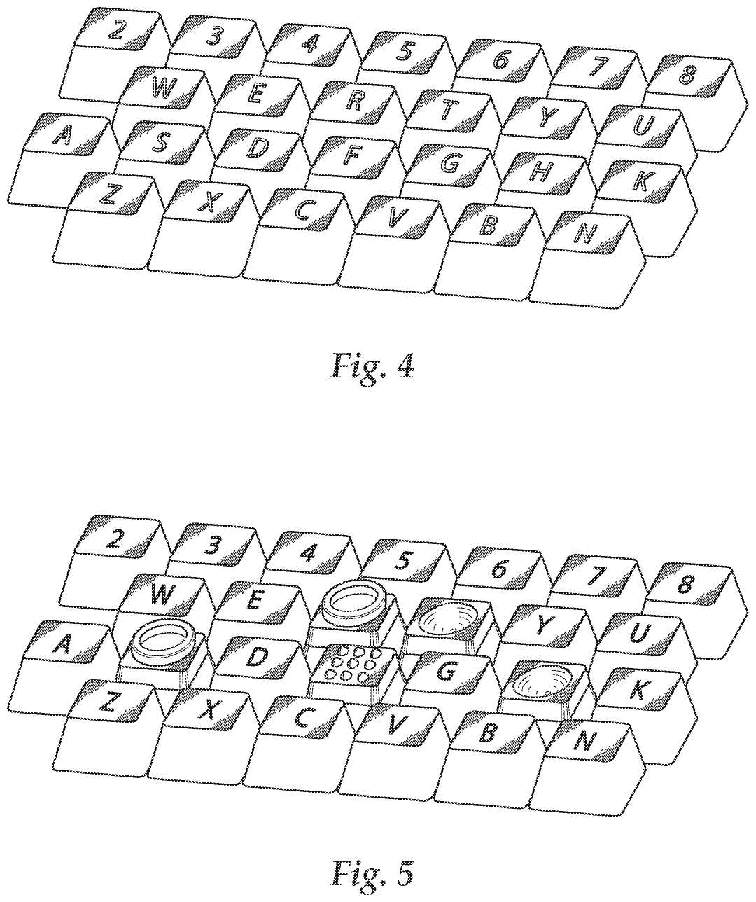

In some embodiments, the lettering component 201 may protrude upward, so as to provide physical cues for a user, as illustrated in FIG. 4.

In some embodiments, the lettering component 201 may be of a specific style or coloring, so as to provide visual cues for a user.

In some embodiments, the lettering component 201 may be illuminated, so as to provide visual cues for a user. One way of implementing this functionality is to include a lighting unit in the keycap base 110. For example, the keycap base 110 may have a recess on its top surface, and a lighting unit may be placed in the recess. The lighting unit may be a LED lighting unit. The lighting unit may emit colored light. The lettering component 201 may be transparent or semi-transparent, for the light to go through, so that the lettering component can be illuminated. The side faces, or parts of the side faces, of the keyboard base 110 may also be transparent, for the light to go through. Alternatively, in some embodiments, the lighting unit may also be embedded in the keyboard top 120 or attached to the bottom surface of the keyboard top, and again, the lettering component 201 may be transparent or semi-transparent for the light to go through. In some embodiment, the light can be turned on or off. For example, the light can be turned on when the keyboard is used in the dark, and turned off when the keyboard is used in a bright environment. For another example, the light can be turned on to indicate the position of a specific key or key binding—for example, if Ctrl+Shift+D is a commonly used combination in an application, the lights on the keycaps indicating “Ctrl”, “Shift”, and “D” may be on and the lights on other keycaps may be off, so that the user can quickly find the desired combination. Also, the lighting unit may emit lights of more than one color, for indicational purposes. For example, if a game has three commonly used key bindings, they may be indicated with different colors of lights. Alternatively, in some embodiments, the lettering component 201 may be of a florescent material.

In some embodiments, the keycap top 120 may include other types of visual indicators not listed above, such as having a distinctive coloring, having an LED light on the top surface of the keycap top, etc.

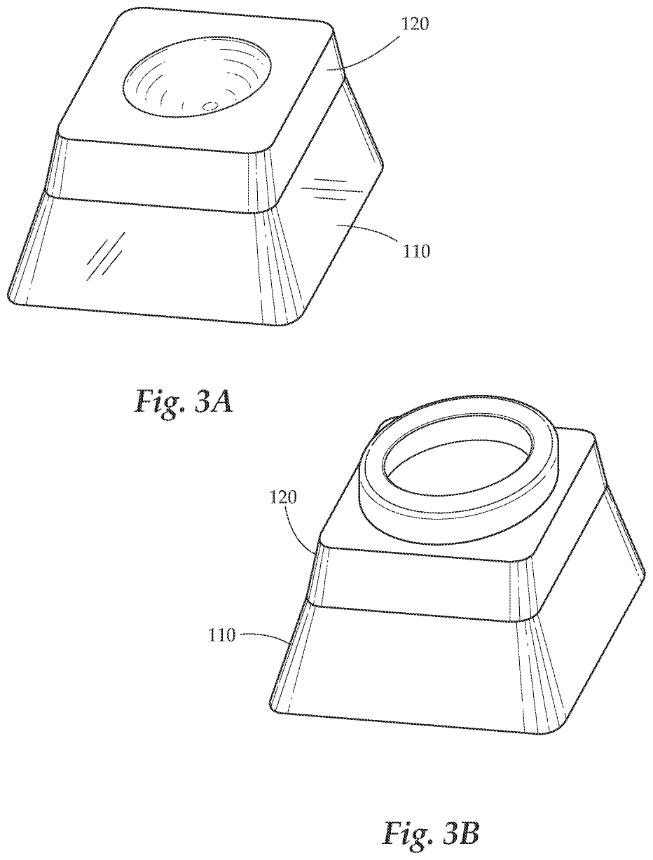

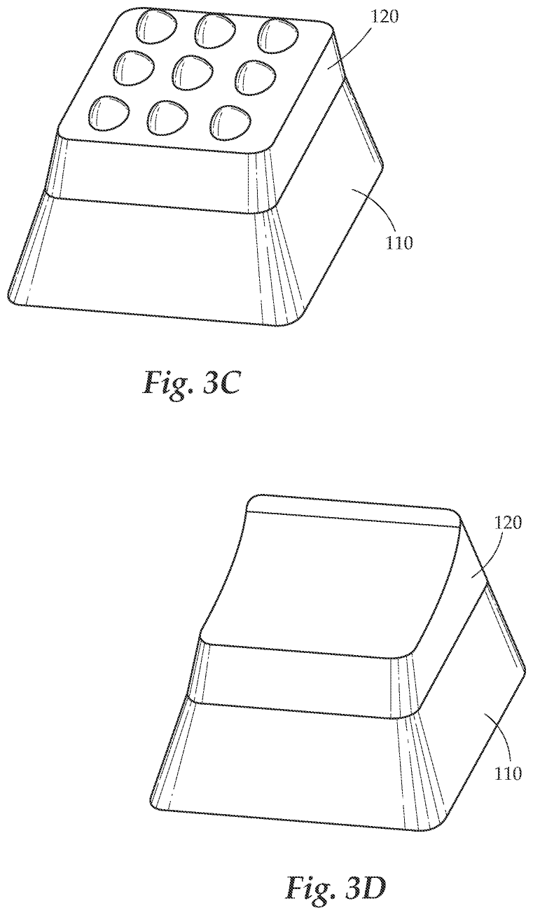

FIGS. 3A-D are illustrations of different textures and shapes the interchangeable keycap top may have, according to some embodiments of the present disclosure.

In some embodiments, the top surface of the keycap top 120 may be shaped or textured.

The shape or texture can provide a physical cue to the user, so that the user does not have to look at the keyboard to know where the input they desire resides on the computer keyboard. The shape or texture may also provide a visual cue to some extent.

In some embodiments, the texture of the top surface of the keycap top 120 may be dotted, lined, rough, smooth, etc. In some embodiments, the top surface of the keycap top 120 may be made of different materials to provide different textures. The shape of the top surface of the keycap top 120 may be flat, concave, angled, convex, having a specific shape like a triangle, a circle, or a square protruding upward, having a recess of a specific shape, etc. For example, FIG. 3A-D shows some of the different textures and shapes a keycap top may have.

FIG. 5 is an illustration of a keyboard with interchangeable keycap tops, wherein some of the keycap tops are textured or have distinctive shapes to provide physical indications for a user, according to one embodiment of the present disclosure. As also seen in FIG. 5, the unique key caps of this disclosure may also be used in conjunction with traditional keyboard keys, in some embodiments.

Because the keycap tops are interchangeable, a user can easily customize the keyboard for different applications. In some embodiments, a keyboard may come with different sets of keycap tops, wherein some keycap tops are “regular”, and some keycap tops are “special” and have distinctive textures, shapes, colors, or other features providing physical and visual cues. For example, the “regular” keycap tops may have smooth surfaces, and the “special” keycap tops may have textured surfaces. A user may put the “special” keycap tops on keys in commonly used shortcuts or key bindings for a game or application and put the “regular” keycap tops on the rest of keys. A user can also move the “special” keycap tops around for different games/applications. In some embodiments, the “special” keycap tops may not have letters, numbers, or symbols written on top of them, so the same keycap top can be moved onto different keycap bases without causing confusion. For example, a textured keycap top may be put onto “A” in one application and onto “B” in another application; it is undesirable to have the letter “A” on the textured keycap top in this use case.

For example, in Game 1, shift+R may be a commonly used shortcut, and in Game 2, shift+T may be a commonly used shortcut. Therefore, when a user is playing Game 1, they may use a textured keycap top for the letter “R”, and a smooth keycap top for the letter “T”, so that they can easily find the letter “R” without looking at the keyboard. Likewise, when the user is playing Game 2, they may instead use a smooth keycap top for the letter “R”, and a textured keycap top for the letter “T”, so that they can easily find the letter “T” instead.

As discussed above, the addition of physical and/or visual cues on the keycap top can help a user locate a keycap more easily. Therefore, the addition of physical and/or visual cues can help gamers/other types of computer users build muscle memory more quickly and reduce mistakes in gaming/using other types of computer applications.

As discussed in the background section, some existing technologies provide physical and visual cues on a keyboard, but none of them teach an easily customizable keyboard that can provide different physical and visual cues for different usages. By introducing an interchangeable keycap top attached to a keycap base with magnetic pieces, the present disclosure provides a method of conveniently customizing a keyboard without using external tools, damaging or causing excessive strain to the keyboard.

Furthermore, unless explicitly stated in the claims, the use of order, numbers, letters, or other names for processing elements and sequences are not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of +20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A keycap, comprising:
a keycap base,
wherein a first magnetic piece is connected to the keycap base;
one or more keycap tops,
wherein a second magnetic piece is connected to each of the one or more keycap tops;
wherein each of the one or more keycap tops defines a tab or cutout on a back side;
wherein the first magnetic piece is a magnet or a non-magnet magnetic material piece;
wherein the second magnetic piece is a magnet or a non-magnet magnetic material piece;
wherein at least one of the first and second magnetic pieces is a magnet.

2. The keycap of claim 1, wherein at least one of the one or more keycap tops includes a lettering component.

3. The keycap of claim 2, wherein the lettering component protrudes upward.

4. The keycap in claim 2, wherein the keycap base includes a light, and wherein the lettering component is transparent or semitransparent.

5. The keycap of claim 1, wherein at least one of the one or more keycap tops has a shaped or textured surface.

6. The keycap of claim 1, wherein at least one of the one or more keycap tops includes a visual indicator.

7. The keycap of claim 1, wherein a top surface of the keycap base and a bottom surface of each of the one or more keycap tops have matched shapes.

8. A method for customizing a keyboard,
wherein the keyboard includes:
a keyboard base;
a plurality of keycap bases connected to the keyboard base,
wherein a first magnetic piece is connected to each of the plurality of keycap bases;
a first group of and a second group of keycap tops,
wherein a second magnetic piece is connected to each of the first group and the second group of keycap tops;
wherein each of the first group and the second group of keycap tops defines a tab or cutout on a back side;
wherein the first magnetic piece is a magnet or a non-magnet magnetic material piece;
wherein the second magnetic piece is a magnet or a non-magnet magnetic material piece;
wherein at least one of the first and second magnetic pieces is a magnet;
wherein each of the second group of keycap tops includes one or more physical or visual indicators;
wherein the method comprises:
selecting and securing keycap tops from the first group of keycap tops to corresponding keycap bases from the plurality of keycap bases;
choosing an application;
identifying one or more target keys that are commonly used for the application;
identifying a target group of keycap bases corresponding to the one or more target keys;
detaching keycap tops from the first group of keycap tops from the target group of keycap bases, using the tab or cutout;
selecting and securing keycap tops from the second group of keycap tops to the target group of keycap bases.

9. The method of claim 8, wherein each of the first group of keycap tops includes a lettering component.

10. The method of claim 9, wherein the lettering component protrudes upward.

11. The method of claim 9, wherein each of the plurality of keycap bases includes a light, and the lettering component is transparent or semitransparent.

12. The method of claim 8, wherein each of the second group of keycap tops has a shaped or textured surface.

13. The method of claim 8, wherein each of the first group of keycap tops has a smooth surface.

14. A customizable keyboard, comprising:
a keyboard base;
a plurality of keycap bases connected to the keyboard base,
wherein a first magnetic piece is connected to each of the plurality of keycap bases;
a first group of and a second group of keycap tops,
wherein a second magnetic piece is connected to each of the first group and the second group of keycap tops;
wherein each of the first group and the second group of keycap tops defines a tab or cutout on a back side;
wherein the first magnetic piece is a magnet or a non-magnet magnetic material piece;
wherein the second magnetic piece is a magnet or a non-magnet magnetic material piece;
wherein at least one of the first and second magnetic pieces is a magnet;
wherein each of the second group of keycap tops includes one or more physical or visual indicators.

15. A customizable keyboard of claim 14, wherein each of the first group of keycap tops includes a lettering component.

16. A customizable keyboard of claim 15, wherein the lettering component protrudes upward.

17. A customizable keyboard of claim 15, wherein each of the plurality of keycap bases includes a light, and the lettering component is transparent or semitransparent.

18. A customizable keyboard of claim 14, wherein each of the second group of keycap tops has a shaped or textured surface.

19. A customizable keyboard of claim 14, wherein each of the first group of keycap tops has a smooth surface.

20. A customizable keyboard of claim 15, further comprising:
a third group of keycap tops, wherein each of the third group of keycap tops includes a lettering component of a non-Latin alphabet, or Braille alphabet.
